(19) United States
(12) Patent Application Publication
(10) Pub. No.: US 2007/0280230 A1
(43) Pub. Date: Dec. 6, 2007

(54) METHOD AND SYSTEM FOR SERVICE DISCOVERY ACROSS A WIDE AREA NETWORK

(75) Inventor: Joon Young Park, Libertyville, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC, Schaumburg, IL (US)

(21) Appl. No.: 11/421,314

(22) Filed: May 31, 2006

(51) Int. Cl. H04L 12/56

(52) U.S. Cl. 370/390; 370/401

(57) ABSTRACT

A method and system for simulating a local area network across a wide area network (109) is provided. The method and system facilitate delivery of multicast communications (303), such as search messages from plug and play applications, from one local area network (100) to another (200), despite the fact that these local area networks (100,200) may be spread distally across a wide area network (109). The system utilizes a trusted group server (308) to forward encapsulated unicast communications (306) to member networked computer devices (202), even when in different domains. Each networked computer device (102,202) includes a gateway interface (301,302) and a local proxy client (304,311). The gateway interface (301) receives multicast communications (306) from multicast applications (313) and delivers them to the local proxy client (304). The local proxy client (304) encapsulates the multicast communications (306) and delivers them to the group server (308), where they are replicated and delivered to all members of the group.

### BACKGROUND

1. Technical Field

This invention relates generally to a system and method for electronic communication, application and service discovery across a wide area network, and more specifically to a system and method of encapsulating and redirecting messages to facilitate electronic communication across the wide area network.

2. Background Art

Computer networking and computer communication are becoming more and more advanced. Not too long ago, a personal computer was an electronic device, like any other appliance, that was used for local work only. A person may use a computer at home for word processing or mathematical tasks. To transfer the files to another computer, like a computer at work for example, the person had to copy the file to a disk and physically take the disk to the work computer.

With the advent of modems, basic computer communication began to emerge. While a person could now call and connect to certain specialized servers, general computer-to-computer communication was difficult. For a person to make his computer “talk” to his home computer, one would have to dial the other. If the second computer was not active, coupled to a phone line, and in “answer” mode, computer-to-computer communication could not occur.

With the advent of the Internet and World Wide Web, combined with standardized communication protocols like the 802.11 standard set forth by the IEEE, all of this changed. Ethernet connections, DSL and cable modems, and even wireless Ethernet cards allow computers to connect to global, wide area networks and communicate with multiple machines. While a child in Kansas once had to go to the library to do a book report, with a personal computer and an Internet connection, the child can now browse books in the world's finest libraries.

To facilitate this explosion in communication, however, there are certain rules to which adherence is mandatory. For example, for computer A to communicate with computer B, computer A must know computer B's “address”. Computer A cannot simply poll a wide area network like the Internet to detect computer B, as the process would take far too long and may overload certain communication channels. Thus, there is an inherent problem in wide area network communication, in that specific addresses must be known before any two computers can talk with each other.

On a local level, computer hardware and software manufacturers have attempted to solve this problem with “plug and play” architectures and systems. With a plug and play system, such as the Universal Plug and Play architecture manufactured by Microsoft, or the Bonjour architecture manufactured by Apple, a user is supposed to be able to “discover” machines and applications running in a local area network. These architectures work by “multicasting” where one device, when plugged into a local area network, sends a broadcast message to every device on the network. This broadcast message essentially says, “Hello, I'm here—please tell me who and what you are . . . ” The devices on the local area network can then reply with a standard address and port identifier, so that the new device can discover other devices and files on the local area network.

While these plug and play systems work well on local area networks, they are ineffective on wide area networks. Local area networks are generally limited to a handful of machines or devices, and are often served by a single node, such as a router. A broadcast message to five devices through a single router is easily accommodated with local area network bandwidth.

However, most Internet Service Providers, and in fact many standards, deliberately prohibit multicasting across a wide area network such as the Internet. This is to prevent multicast messages from crashing the wide area network. Imagine if the hundreds of millions of machines coupled to the Internet all began sending and receiving messages from every other machine. The flooded communication traffic would grow exponentially and would cause demand to exceed bandwith, thereby creating network failures. For this reason, all multicast messages are designated with a “time to live” (TTL) value that is set to one. This time to live value decreases by one each time the message is received and forwarded by a router; once the value reaches zero the message is dropped from the network. Thus, if the multicast message fails to discover other devices after hitting a single node or router, the message is killed. This time to live feature keeps wide area network communication loads within the limits of their bandwidth. Thus, multicast discovery is simply not effective across wide area networks.

There is thus a need for a system and method for service discovery that functions across a wide area network.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a local area network having multiple devices in communication.

FIG. 2 illustrates one embodiment of multiple local area networks coupled to a wide area network.

FIG. 3. illustrates one embodiment of system components facilitating service discovery across a wide area network in accordance with the invention.

FIG. 4 illustrates one embodiment of a system for service discovery across a wide area network in accordance with the invention.

FIG. 5 illustrates communication flow through one embodiment of a system for service discovery across a wide area network in accordance with the invention.

FIG. 6 illustrates one embodiment of a method for sending communications for service discovery across a wide area network in accordance with the invention.

FIG. 7 illustrates one embodiment of a method for receiving communications for service discovery across a wide area network in accordance with the invention.

FIG. 8 illustrates one embodiment of a method for processing communications for service discovery across a wide area network in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to facilitate service discovery across a wide area network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of service discovery across a wide area network as described herein. The non-processor circuits may include, but are not limited to, Ethernet transceivers, Internet communications, signal drivers, clock circuits, power source circuits, and user input devices. As such, these functions may be interpreted as steps of a method to perform service discovery across a wide area network. Alternatively, some or all functions could be implemented by a state machine that has no stored program instructions, or in one or more application specific integrated circuits, in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

The present invention provides a system and method for service discovery across a wide area network such as the Internet. The invention accomplishes the service discovery by transferring multicast communications, such as those generated in plug and play architectures, from one local area network, across a wide area network, to another local area network. A group server, coupled to the wide area network, handles these direct local area network to local area network communications. The group server is visible to all devices in both local area networks.

The devices in the local area networks, being in communication with the group server, form a “virtual group”. The virtual group is ultimately connected through the wide area network, but for applications running in either local area network, the other devices of the virtual group appear to be connected locally. Thus, by being identified and connected with the group server, devices like personal computers, gaming devices, music and multimedia players, and Internet compatible television set-top boxes are able to share files, applications, and content as if they were all connected to a common node or server. Further, multicast discovery protocols, such as Universal Plug and Play and Bonjour, can discover new devices with multicast communications even where the new machines are attached to the virtual group half way around the world.

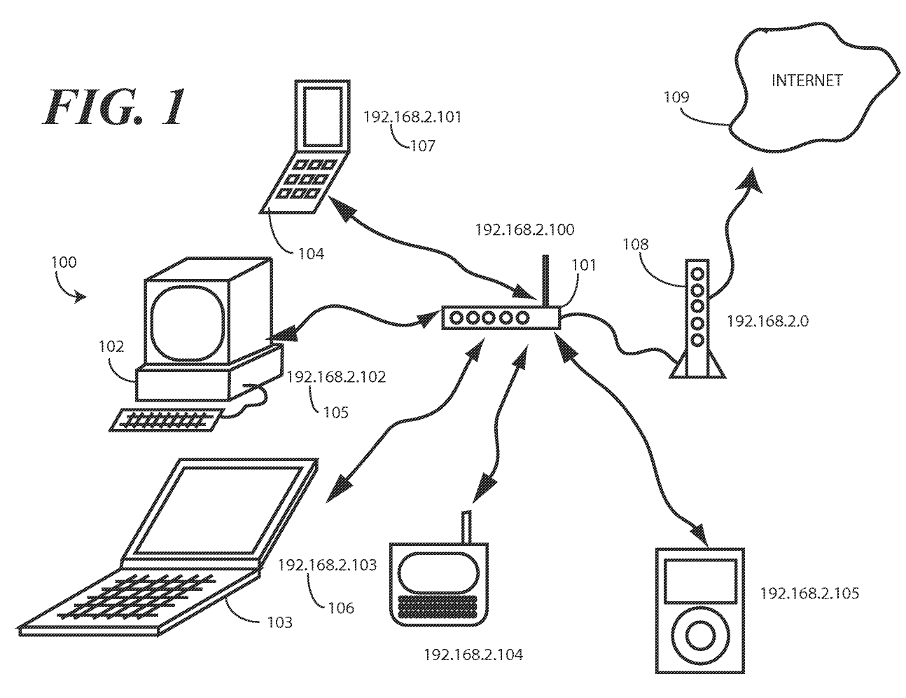

Turning now to FIG. 1, illustrated therein is one embodiment of a local area network 100 having devices, e.g. 102,103,104 in communication. The local area network 100 includes a local node 101, shown here as a router, that facilitates wired or wireless communication between one or more devices.

For example a first networked computer device 102, shown here as a personal computer, having a first address 105, may send a communication to a second computer 103 having a second address 106. Similarly, the first networked computer device 102 may send a communication to a mobile telephone 104 having a third address. Each communication is handled by the local node 101. The local node 101 or router acts as a symphony conductor of sorts by directing communications from one device to the next across the local area network 100. When a device sends a communication to a specifically addressed device that is not communicating on the local area network 100, the local node 101 directs the communication to the wide area network interface 108, which may be a cable modem, DSL modem, or T1 line communication interface.

When plug and play systems like Universal Plug and Play or Bonjour are being used, a networked computer device 102, for example the personal computer, may send a multicast communication to the local node 101. This multicast communication will include computer 102's address and port identifiers. The local node 101 will deliver this communication to each of the other devices, e.g. computer 103, mobile telephone 104, etc. Each device will then respond, thereby allowing networked computer device 102 to determine what devices are connected to the local area network 100. Upon discovery, presuming the proper permissions are in place, networked computer device 102 would be able to share files and applications with other devices on the local area network 100. For example, networked computer device 102 may access a photograph or musical recording stored on a hard drive of computer 103.

The local node 101 may deliver the multicast communication to the wide area network interface 108. However, as multicast communications have a time to live equal to one, the multicast communication will stop at the wide area network interface 108. This is due to the fact that it has passed from the local node 101 to the wide area network interface 108, for a total of two nodes. As the time to live of one has been exceeded, the wide area network interface 108 will not forward the communication to the wide area network 109, thereby preventing overloading the bandwidth of the wide area network 109.

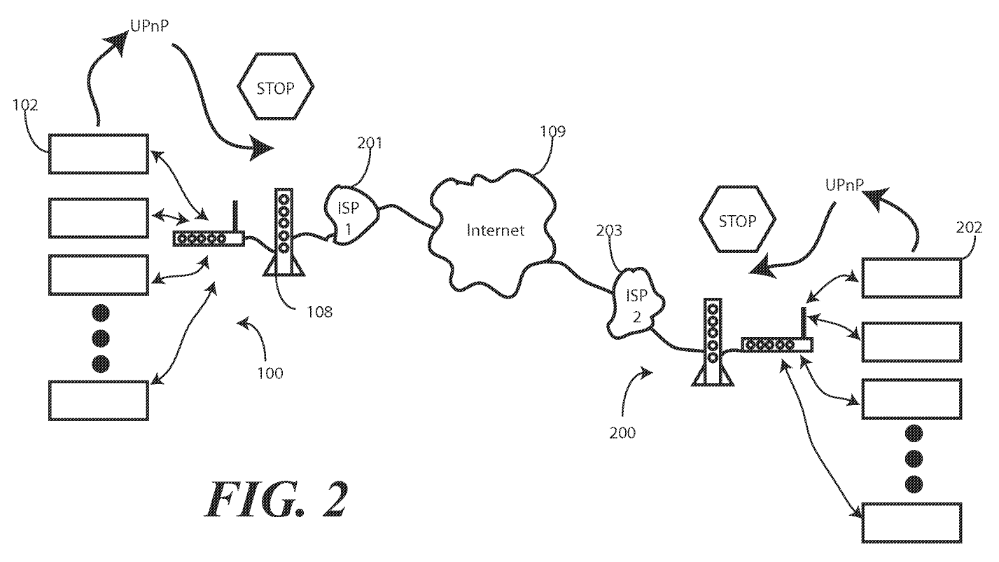

Turning now to FIG. 2, illustrated therein is a view of a first local area network 100 and a second local area network 200 each coupled to a wide area network 109. Suppose, for example, that the first local area network 100 belongs to a daughter. The second local area network 200 belongs to her father. The daughter and father would like to be able to share files and applications, such as family portraits, movies, and music. However, when the girl attempts to send a multicast communication to discover a networked computer device 202 on her father's local area network 200, the multicast communication dies at her wide area network interface 108.

To make matters worse, the girl's local area network 100 is serviced by a first service provider 201, while her father's local area network 200 is serviced by a second service provider 203. Many times, different service providers have different technologies and different addressing protocols, which makes direct communication extremely difficult. It is just this type of problem that the present invention seeks to resolve.

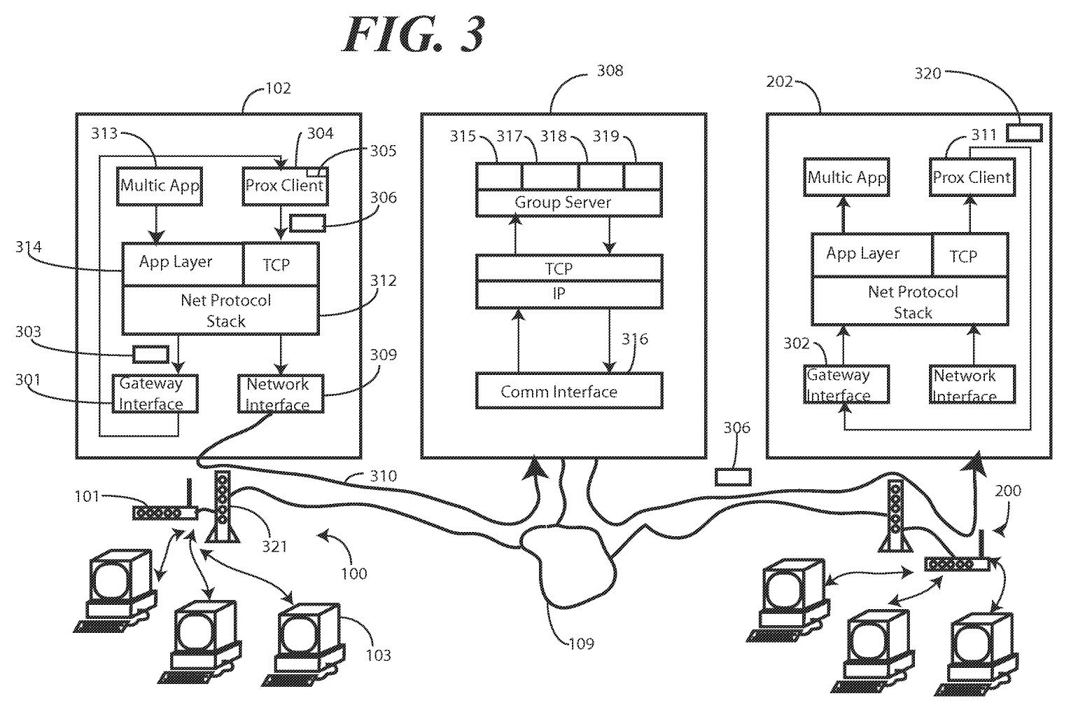

Turning now to FIG. 3, illustrated therein are system components facilitating service discovery over a wide area network in accordance with one embodiment of the invention. A first networked computer device 102 is associated with a first local area network 100. A second networked computer device 202 is associated with a second local area network 200. As noted in the discussion of FIG. 1, these networked computer devices 102,202 could be any of a variety of devices, including personal computers, gaming devices, and multimedia players. Additionally, these devices may also be Interactive Connectivity Establishment (ICE) devices.

The Interactive Connectivity Establishment is a communication protocol standard drafted by Internet Engineering Task Force for network address translation traversal. Network address translation traversal refers to a solution to the common problem in TCP/IP networking of establishing connections between hosts in private TCP/IP networks that use network address translation devices. Interactive Connectivity Establishment devices, sometimes referred to as “ICE boxes”, often incorporate multiple forms of content into a single unit. For example, an ICE box may allow a user to receive both television and web browsing content.

Each networked computer device 102,202 includes a multicast application 313, an application layer 314, and a network protocol stack 312. The multicast application 313 is a module or application running within the networked computer device 102 that is capable of initiating multicast communications 303. Examples of multicast applications 313 include Universal Plug and Play software modules, Bonjour software modules, and multicast DNS modules. One example of a multicast communication 303 might be a Universal Plug and Play announcement message when one of the devices 102,202 is actuated.

The multicast application 313 is in communication with the network protocol stack 312 by way of the application layer 314. Thus, upon initiation of multicast communications 303, the multicast application 313 delivers the multicast communication 303 to the network protocol stack 312 through the application layer 314.

The network protocol stack 312 is configured to receive the multicast communication 303 and convert the multicast communication into a frame suitable for delivery to a local network gateway interface or local network node 101, such as a local area network router, through a local network interface 321. In one embodiment, the network protocol stack 312 includes at least TCP, UDP and IP protocol elements for converting the multicast communication 303 into frames. The network protocol stack 312 then replicates and routes the multicast communication 303 to both a local network node 101 and to a gateway interface 301.

Each networked computer device 102,202 includes a gateway interface 301,302, which is an application running within the networked computer device 102. Using networked computer device 102 as an example, the gateway interface 301 is configured to receive a multicast communication 303 from network protocol stack 312. The gateway interface 301 generates Ethernet frames and delivers them to a local proxy client 304.

As noted above, under normal operation, the multicast applications 313 running within the networked computer device 102 would send such multicast communications to a local node 101 or router for distribution to other devices, e.g. computer 103, on the local area network 100. Thus, a Universal Plug and Play communication would be delivered to local node 101 and then to other devices on the local area network 100. With the present invention, such communications are also delivered to the gateway interface 301. The gateway interface 301, which is configured to simulate a network interface to the network protocol stack 312 within the networked computer device 102, then delivers this multicast communication 303 to a local proxy client 304, rather than broadcasting it to the local area network 100.

The local proxy client 304 is a user space process that acts as a proxy between the networked computer device 102 and the wide area network 109. The local proxy client 304, which has a unique identifier 305 associated therewith, is configured to encapsulate the multicast communication 303 within an encapsulated unicast communication 306. An example of a unique identifier may be the devices MAC address. In one embodiment, the local proxy client 304 is configured to encapsulate the multicast communication 303 outside both the network protocol stack 312 and the application layer 314. The local proxy client 304 then delivers the encapsulated unicast communication 306 across the wide area network 109 to a group server 308 by way of a network interface 309.

The networked computer device 102 uses the network interface 309 to communicate with the wide area network 109. As such, the local proxy client 304 is in communication with the wide area network 109 by way of the network interface 309. The network interface 309 is configured to establish a secure communication channel 310 with the group server 308 across the wide area network 109. So that the group server 308 knows from which networked computer device the encapsulated unicast communication is being transmitted, in one embodiment the local proxy client 304 is configured to associate the encapsulated unicast communication 306 with the unique identifier 305 prior to delivering the encapsulated unicast communication 306 to the group server 308.

The local proxy client 304, working through the network interface 309, makes a secure transport, or application level, connection with the group server 308. The local proxy client 304 then sends the encapsulated unicast communication 306 as Ethernet frames to the group server 308. Typical examples of communication protocols between the local proxy client 304 and the group server 308 include hypertext transfer protocol (HTTP), secure hypertext transfer protocol (HTTPS), and file transfer protocol (FTP).

Thus to recap, with one embodiment of the present invention, multicast communications 303, which are typically only delivered to a local node 101 with a time to live of one, are in parallel delivered to the gateway interface 301. The gateway interface 301 then delivers the multicast communication 303 to the local proxy client, which encapsulates the multicast communication 303 within an encapsulated unicast communication 306. As such, the local proxy client 304 is configured to simulate a local area network across a wide area network.

The encapsulated unicast communication 306 is then delivered to the group server 308. Prior to delivery of the encapsulated unicast communication 306, the local proxy client 304 is configured to authenticate the networked computer device 102 with the group server 308 and to register the networked computer device 102 with the group server 308. The registration may occur when the networked computer device 102 is initially powered up. The local proxy client 304 may register the networked computer device 102 with the group server 308 by delivering, for example, an Internet protocol address to the group server 308. The authentication, which may occur whenever the local proxy client 304 communicates with the group server 308, may occur by the local proxy client 304 delivering the unique identifier 305 to the group server 308.

The group server 308 has a plurality of user groups stored in a group database 315. The user groups are collections of networked computer devices that have been registered into user groups by their users. Devices are recognized as belonging to a group, in one embodiment, by the unique identifiers, e.g. 305. The group server 308 includes an authentication and registration module 319, which is configured to associate the unique identifier 305 with at least one group, and to write the at least one group to the group database. Thus, the group database 315 has networked computer device addresses stored therein, where the networked computer device addresses correspond to a group associated with the unique identifier 305.

By way of example, networked computer device 102, operating on local area network 100, may be registered in the same user group as networked computer device 202, which operates on local area network 200. This user group is stored by the group server 308 in the group database 315. Since, in this example, the devices 102,202 operate in different domains, the networked computer addresses stored in the group database 315 would belong to at least two domains.

The group server 308 is configured to simulate a local area network across a wide area network by receiving encapsulated unicast communications 306 from one member of the group, and delivering the encapsulated unicast communication 306 to every other member of the user group. The group server includes a communication interface 316 coupled to the wide area network 109, and a communication receiving module 317 that is operable with the communication interface 316. The communication receiving module 317 is configured to receive the encapsulated unicast communication 306 having the unique identifier 305 associated therewith. From this unique identifier 305, the group server 308 may access the group database to determine what other devices belong to the group corresponding to the unique identifier 305.

A delivery module 318, operable with the communication interface 316, is configured to deliver the encapsulated unicast communication 306 to a networked computer device 202 in the group. The delivery module 318 replicates the encapsulated unicast communication 306 and delivers the encapsulated unicast communication 306 to each of the plurality of networked computer devices belonging to the group. Thus, when a networked computer device has a networked computer device address associated with the group, it will receive a copy of the encapsulated unicast communication 306. Since persistent authentication may be cumbersome and may consume bandwidth, in one embodiment, the group server 308 may use a session initiation protocol to signal to a networked computer device that a communication delivery is eminent.

Continuing with the example where networked computer device 102 and networked computer device 202 are in the same group, the group server will deliver the encapsulated unicast communication 306 to networked computer device 202. The local proxy client 304, capable of transmitting encapsulated unicast communications 306 as noted above, it is also used to receive such communications. For example, assuming that the local proxy client 304 of networked computer device 102 transmits an encapsulated unicast communication 306, the local proxy client 311 of networked computer device 202 is configured to receive the encapsulated unicast communication 306 from the group server 308. The local proxy client 311 then de-encapsulates the encapsulated unicast communication 306 as a de-encapsulated multicast communication 320. The local proxy client 311 then delivers the de-encapsulated multicast communication 320 to the gateway interface 302.

Upon receipt of a de-encapsulated multicast communication 320 from the local proxy client 311, the gateway interface 302 is configured to determine an application address associated with the de-encapsulated multicast communication 320. For example, where the de-encapsulated multicast communication 320 is a search message for video content, the application address may be associated with video software modules operating within the networked computer device 202. The gateway interface 302 then delivers the de-encapsulated multicast communication 320 to the appropriate application address.

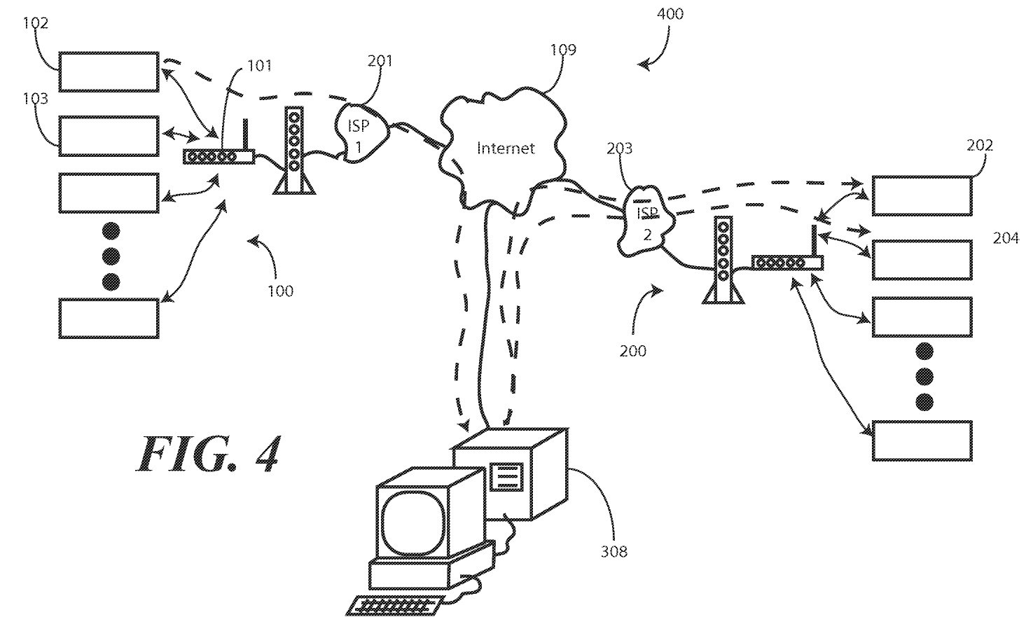

Turning now to FIG. 4, illustrated therein is one embodiment of a system 400 for service discovery across a wide area network 109 in accordance with the invention. As with FIG. 2, a first local area network 100 and second local area network 200 are coupled to a wide area network 109, such as the Internet. Within the first local area network 100 are coupled various devices 102,103. Similarly, other devices 202,204 are coupled within the second local area network.

In FIG. 4, a networked computer device 102 not only delivers a multicast communication (303) to its local area network 100, but it also delivers the multicast communication (303) to other networked computer devices 202,204, where these other networked computer devices 202,204 are in the same group as networked computer device 102. These other networked computer devices 202,204 may be connected to the first networked computer device 102 only by a wide area network. Further, while the other networked computer devices 202,204 may be in different domains, and may be served by a different service provider 203 that the service provider 201 providing service to networked computer device 102.

This “multicast communication across a wide area network” is accomplished, as discussed in FIG. 3, by the group server 308. The group server 308 includes group information in the group database (315). The networked computer devices 102,202,204 communicate with multicast communications by delivering encapsulated unicast communications to the group server 308. The group server 308, having knowledge and address information corresponding to each device in the group, facilitates a “virtual Ethernet” across the wide area network 109.

The gateway interface of each device (301,302) operates as a special type of network interface. It is seen by the operating system as a normal, local area network, Ethernet device. However, as described above, instead of forwarding the Ethernet frames to a hardware local node 101, the gateway interface (301,302) forwards the received Ethernet frames to the local proxy client (304,311), which is a user space process.

The local proxy client (304,311) then forwards the Ethernet frames comprising the encapsulated unicast communication to the group server 308, which forwards them to the other networked computer devices within the group. Those other networked computer devices, networked computer devices 202,204 in the exemplary embodiment of FIG. 4, then receive the Ethernet frames by way of their local proxy clients. The local proxy clients then forward the incoming Ethernet frames to operating system kernels of those networked computer devices.

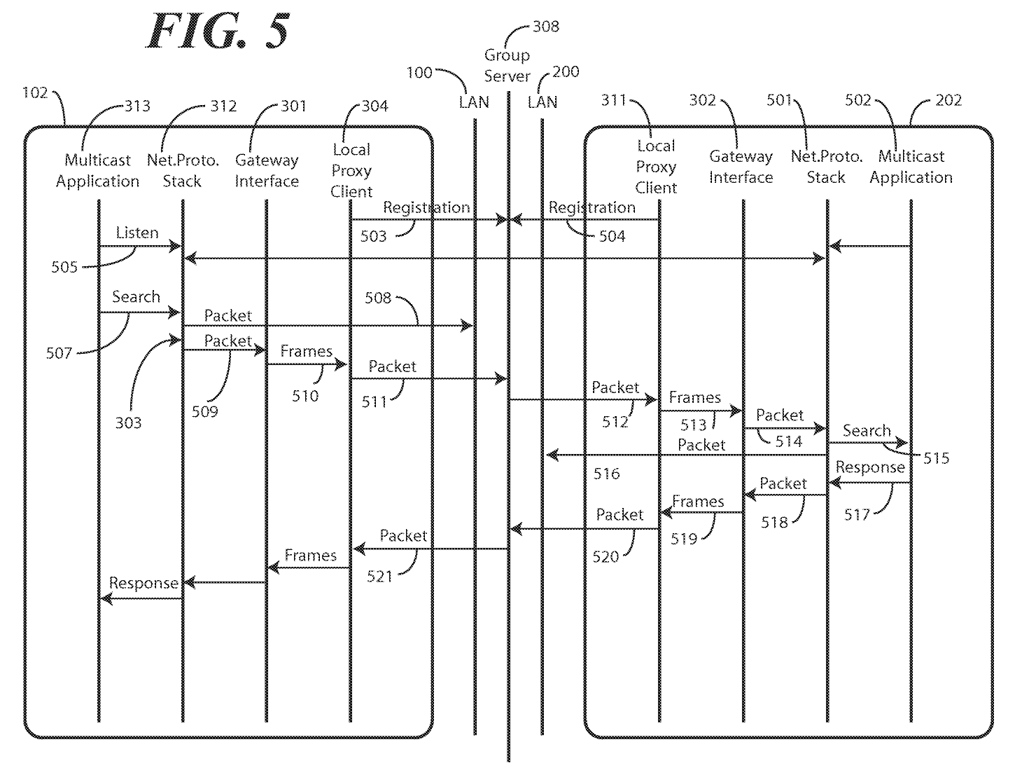

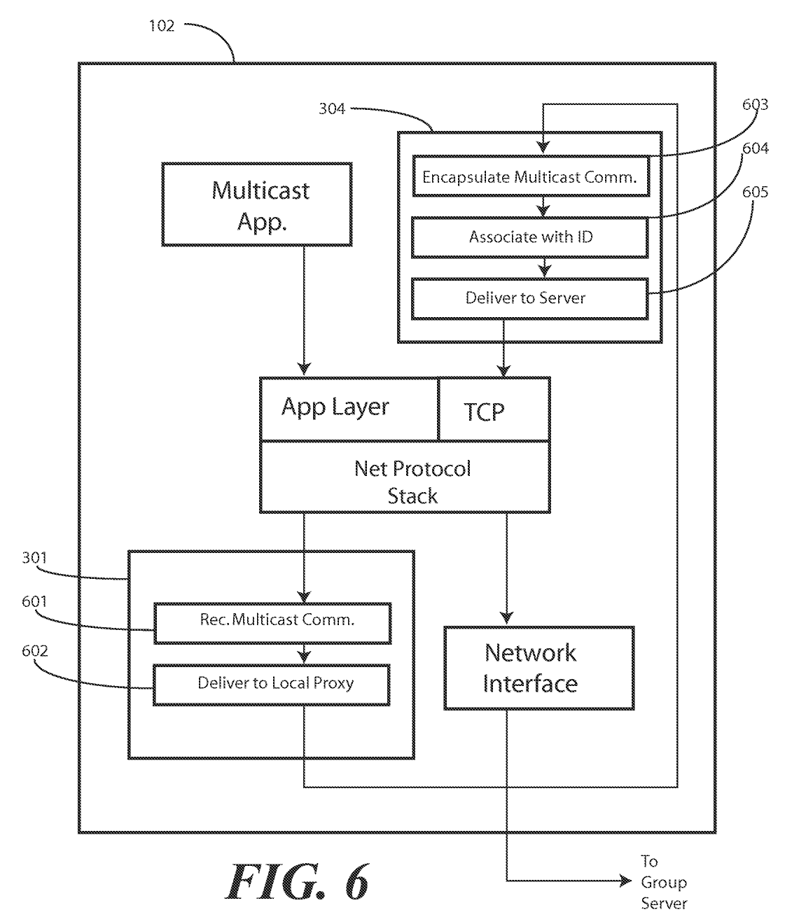

Turning now to FIG. 5, illustrated therein is one embodiment of a method for sending communications for service discovery across a wide area network in accordance with the invention. FIG. 6 illustrates a scenario of how a multicast communication 303, such as a search message from a Universal Plug and Play or Bonjour software application, is generated in a networked computer device 202 operating in one local area network 100 and is then transferred to a second networked computer device 202 operating in a second local area network 200.

From the perspective of each networked computer device 102,202, the group server 308 is a server hosted by a trusted entity. Both networked computer devices 102,202 are able to access the group server 308 by way of a wide area network. One exemplary means of access is using a secure protocol, such as the secure hypertext transfer protocol.

Where each networked computer device 102,202 is behind a network access translation device, a network access translation mechanism, such as the Interactive Connectivity Establishment standard, may be employed. The network access translation mechanism allows the group server 308 to initiate communication with either networked computer device 102 or networked computer device 202.

When each networked computer device 102,202 powers up, the local proxy clients 304,311 registers 503,504 the respective locations or addresses of the networked computer devices 102,202. For example, the local proxy clients 304,311 may deliver the respective Internet protocol addresses to the group server 308. During an authentication process, the local proxy clients 102,202 deliver client information, which may include the unique identification and MAC address, to the group server 308.

Multicast applications 313,502 operating within the networked computer devices 102,202 are capable of generating multicast communications. Examples of some multicast applications include Universal Plug and Play or multicast DNS. At 505,506 the multicast applications 313,502 “listen” to communications on multicast channels within their respective local area networks 100,200. At 507, multicast application 313 initiates a multicast communication, which may for example be a search message. At 508, the search message is delivered to the local area network 100. Concurrently, at 509 the search message is replicated for the gateway interface 301. In one embodiment, network protocol stack 312 may include a filter so that it can only replicate application-level packets from local discovery service protocol elements.

At step 510, the replicated packets of the search message are converted to Ethernet frames, which are in turn sent to the local proxy client 304. The local proxy client 304 establishes a secure transport connection to the group server 308 and delivers the Ethernet frames 511 to the group server 308 at 511. The Ethernet frames delivered by the local proxy client 304 are actually encapsulated Ethernet frames. They are encapsulated as an encapsulated unicast communication.

From the group database (315) the group server 308 knows all member networked computer devices within a particular group. When the group server 308 receives the encapsulated Ethernet frames, it replicates the encapsulated Ethernet frames and sends them to all networked computer devices within the group. As shown in FIG. 5, the group server 308 delivers the encapsulated Ethernet frames to the networked computer device 202.

Upon receipt of the encapsulated Ethernet frames, the receiving local proxy client 311 takes the Ethernet frames out of the IP packet and sends the Ethernet frames to the gateway interface 302 at 513. The gateway interface 302 generates network protocol packets out of the Ethernet frames and sends the packets to the network protocol stack 501 at 514. Where the packets include a local service discovery protocol element, such as a search command for instance, the network protocol stack 501 may contain some of local service discovery protocol elements. As such, the network protocol stack 501 not only sends the search command to the multicast application 502 at 515, but may also multicast the packets to the local area network 200 at 516 such that other networked computer devices operating within local area network 200 may likewise be discovered.

Where the local proxy server 311 corresponds to the relevant networked computer device that multicast application 313 is seeking, multicast application 502 will send unicast response messages with destination addresses to the multicast application 313. Address translation may be included, as there is a remote possibility that the two networked computer devices 102,202 may have the same address, despite belonging to two different local area networks 100,200.

The unicast response messages are delivered to the network protocol stack 501 at 517, where it is translated into packets. The packets are delivered to the gateway interface 302 at 518, where the gateway interface 302 generates Ethernet frames and sends them to the local proxy client 311 at 519. The local proxy client 311 encapsulates the Ethernet frames and sends the encapsulated Ethernet frames to the group server at 520 by secure transport. The encapsulated Ethernet frames are then delivered to local proxy client 304 at 521, where they ultimately arrive at multicast application 313.

Turning now to FIG. 6, illustrated therein is one embodiment of a method for sending messages for service discovery across a wide area network in accordance with the invention. The method may be implemented by software modules operating within the networked computer device 102. As with the networked computer devices of the previous figures, in one embodiment, the networked computer device 102 includes a gateway interface 301 and a local proxy client 304. The details of these components have been explained in previous figures. As such, only the method steps will be described here.

The method of FIG. 6 is directed towards generation of multicast and encapsulated unicast messages. The method is for a networked computer device 102 having at least a gateway interface 301 and a local proxy client 304, and may be used for simulating a local area network across a wide area network in accordance with the invention.

Within the gateway interface 301, a multicast communication is received at step 601. As noted above, this multicast communication may come from a multicast application operating within the networked computer device 102. Upon receipt of this multicast communication, the gateway interface 301 delivers the multicast communication to the local proxy client 304. Also as noted above, in one embodiment, the local proxy client 304 includes unique identifier indicia, such as a MAC address, associated therewith.

Within the local proxy client 304, upon receipt of the multicast communication from the gateway interface 301, the multicast communication is encapsulated within an encapsulated unicast communication at step 603. As the encapsulated unicast communication is to be delivered to a group server (308), the local proxy client 304 may also associate the encapsulated unicast communication with the unique identifier indicia at step 604. The local proxy client 304 then delivers the encapsulated unicast communication to the group server (308) that is in communication with the wide area network (109) at step 605.

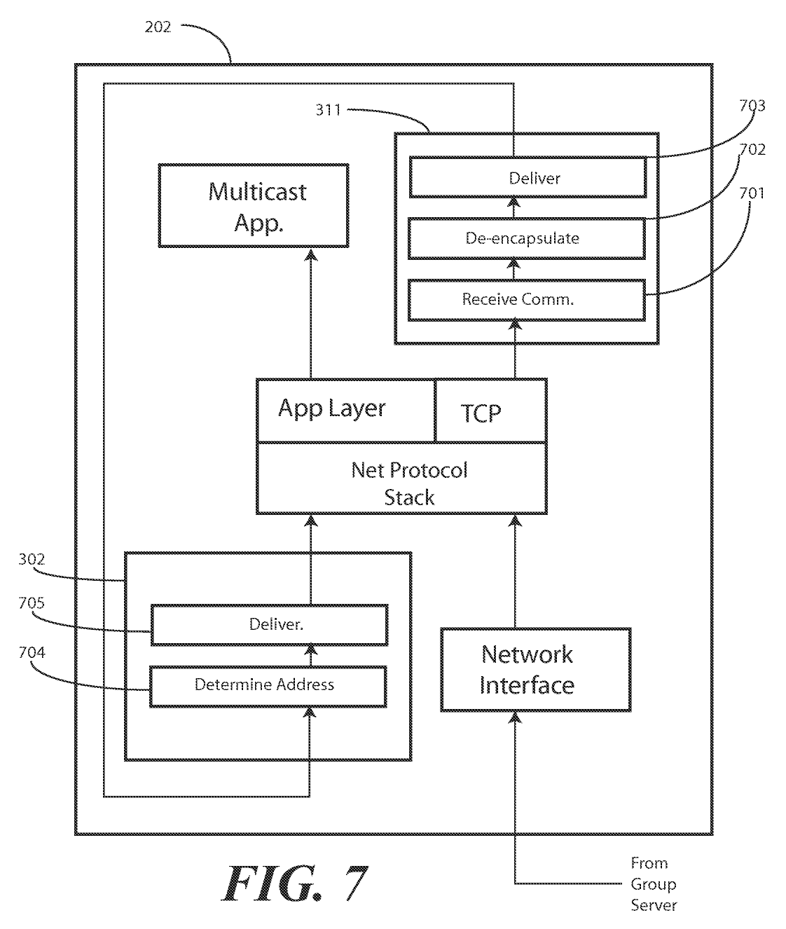

Turning now to FIG. 7, illustrated therein is a method for a networked computer device 202 to receive encapsulated unicast communications from the group server (308). Within the local proxy client 311, at step 701, an incoming unicast encapsulated multicast communication is received. At step 702, the local proxy client 31 de-encapsulates the incoming unicast encapsulated multicast communication as a de-encapsulated communication. At step 703, the local proxy client 311 delivers the de-encapsulated communication to the gateway interface 302.

Within the gateway interface 302, at step 704, an application address of the de-encapsulated communication is determined. At step 705, the gateway interface 302 delivers the de-encapsulated communication to an application address within the networked computer device 202. The application address may be, for example, a memory address for a software application currently in operation.

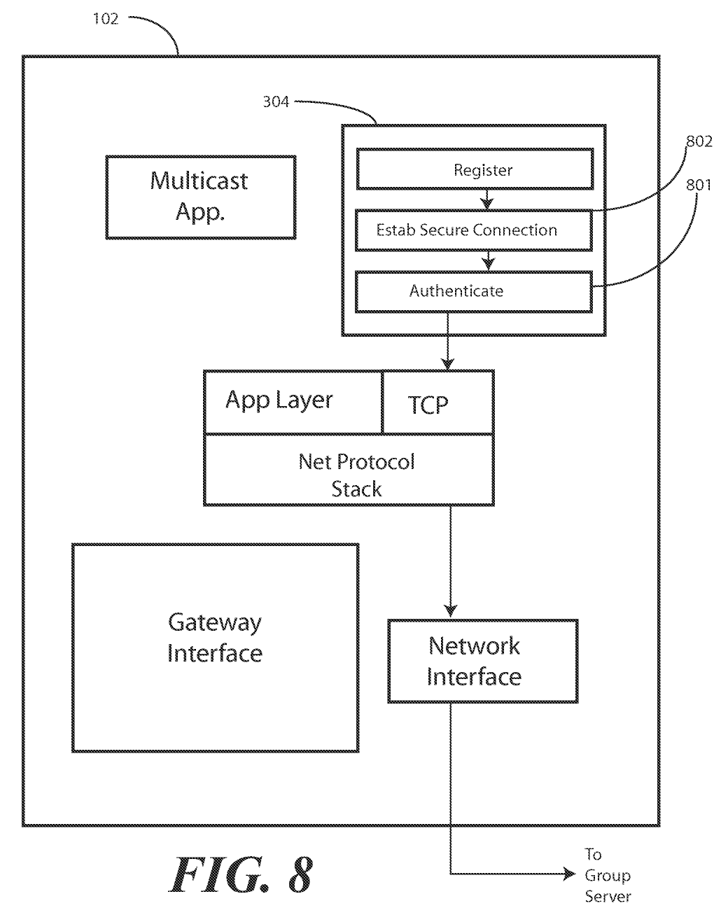

Turning now to FIG. 8, illustrated therein is a method of authentication and communication establishment that may be used with a networked computer device in accordance with the invention. For discussion purposes, networked computer device 102 will be used as an exemplary networked computer device.

At step 801, within the local proxy client 304, the local proxy client 304 authenticates the networked computer device 102 with a group server (308). This authentication may occur upon actuation of the networked computer device 102. Further, the group server (308) and the networked computer device 102 may both be in communication with a wide area network (109). At step 802, the local proxy client 304 may establish a secure communication channel with the group server (308).

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. A networked computer device, the networked computer device comprising a gateway interface configured to receive a multicast communication and to deliver the multicast communication to a local proxy client having a unique identifier associated therewith, the local proxy client being configured to encapsulate the multicast communication within an encapsulated unicast communication and to deliver the encapsulated unicast communication to a group server.

2. The networked computer device of claim 1, wherein the local proxy client is configured to associate the encapsulated unicast communication with the unique identifier prior to delivering the encapsulated unicast communication to the group server.

3. The networked computer device of claim 1, further comprising a network interface, wherein the local proxy client is in communication with at least a wide area network by the network interface.

4. The networked computer device of claim 3, wherein the network interface is configured to establish a secure communication channel with the group server across the at least a wide area network.

5. The networked computer device of claim 1, wherein the local proxy client is configured to receive encapsulated unicast communications from the group server, to de-encapsulate the encapsulated unicast communications as de-encapsulated multicast communications, and to deliver the de-encapsulated multicast communications to the gateway interface.

6. The networked computer device of claim 5, wherein upon receipt of a de-encapsulated multicast communication from the local proxy client, the gateway interface is configured to determine an application address, and deliver the de-encapsulated multicast communication to the application address.

7. The networked computer device of claim 1, further comprising a network protocol stack in communication with the gateway interface and an application layer in communication with the network protocol stack.

8. The networked computer device of claim 7, wherein the local proxy client is configured to encapsulate the multicast communication outside both the network protocol stack and the application layer.

9. The networked computer device of claim 7, wherein the gateway interface is configured to simulate a network interface to the network protocol stack.

10. The networked computer device of claim 7, further comprising a multicast application capable of initiating multicast communications, wherein the multicast application is in communication with the network protocol stack such that upon initiation of the multicast communications, the multicast communications are delivered to the network protocol stack.

11. The networked computer device of claim 10, wherein the network protocol stack is configured to receive the multicast communication and convert the multicast communication into a frame suitable for delivery to a local network node.

12. The networked computer device of claim 11, wherein the network protocol stack includes at least TCP, UDP and IP protocol elements.

13. The networked computer device of claim 1, wherein the local proxy client is configured to simulate a local area network across a wide area network.

14. The networked computer device of claim 1, further comprising a local network gateway interface configured to receive multi-cast communications and deliver them to a local network node.

15. The networked computer device of claim 1, wherein the local proxy client is configured to authenticate the networked computer device with the group server and to register the networked computer device with the group server.

16. The networked computer device of claim 15, wherein the local proxy client registers the networked computer device with the group server by delivering an Internet protocol address to the group server.

17. The networked computer device of claim 15, wherein the local proxy client authenticates the networked computer device with the group server by delivering the unique identifier to the group server.

18. A method in a networked computer device having at least a gateway interface and a local proxy client for simulating a local area network across a wide area network, the method comprising the steps of:
a. within the gateway interface,
i. receiving a multicast communication; and
ii. delivering the multicast communication to the local proxy client having a unique identifier indicia associated therewith; and
b. within the local proxy client,
i. encapsulating the multicast communication within an encapsulated unicast communication;
ii. associating the encapsulated unicast communication with the unique identifier indicia; and
iii. delivering the encapsulated unicast communication to a group server in communication with the wide area network.

19. The method of claim 18, further comprising the steps of:
a. within the local proxy client,
i. receiving an incoming unicast encapsulated multicast communication;
ii. de-encapsulating the incoming unicast encapsulated multicast communication as a de-encapsulated communication; and
iii. delivering the de-encapsulated communication to the gateway interface;
b. within the gateway interface,
i. determining an application address of the de-encapsulated communication; and
ii. delivering the de-encapsulated communication to the application address within the networked computer device.

20. The method of claim 18, further comprising the step of, upon actuation of the networked computer device, authenticating the networked computer device with the group server in communication with the wide area network.

21. The method of claim 18, further comprising the step of establishing a secure communication channel with the group server in communication with the wide area network.

22. A group server configured to simulate a local area network across a wide area network, the group server comprising:
a. a communication interface coupled to the wide area network;
b. a communication receiving module operable with the communication interface, the communication receiving module being configured to receive a encapsulated unicast communication having a unique identifier associated therewith;
c. a group database, the group database having at least one networked computer device address stored therein, the at least one networked computer device address corresponding to a group associated with the unique identifier; and
d. a delivery module operable with the communication interface, the delivery module being configured to deliver the encapsulated unicast communication to a networked computer device having the at least one networked computer device address associated therewith.

23. The group server of claim 22, wherein the at least one networked computer device address comprises a plurality of networked computer addresses, wherein the delivery module is configured to replicate the encapsulated unicast communication and to deliver the encapsulated unicast communication to each of the plurality of networked computer addresses.

24. The group server of claim 23, wherein at least two of the plurality of networked computer addresses belong to at least two domains.

25. The group server of claim 22, further comprising an authentication and registration module, wherein the authentication and registration module is configured to associate the unique identifier with at least one group, and to write the at least one group to the group database.
